(19) United States
(12) Patent Application Publication
(10) Pub. No.: US 2012/0140931 A1
(43) Pub. Date: Jun. 7, 2012

(54) METHODS TO MIX A MULTI-CHANNEL INTO A 3-CHANNEL SURROUND

(75) Inventor: Zihui Shen, Nanjing (CN)

(73) Assignee: Guangzhou Aivin Audio Co., Ltd. Guoguang Electric Co., Ltd., Guangzhou (CN)

(21) Appl. No.: 13/287,187

(22) Filed: Nov. 2, 2011

(30) Foreign Application Priority Data
Dec. 1, 2010 (CN) 2010-10568538.4

(51) Int. Cl. H04R 5/00

(52) U.S. Cl. 381/17

(57) ABSTRACT

This invention is related to audio field, providing a method to downmix multi-channel sounds into a 3-channel surround sound. This invention concerns reprocessing of encoded traditional multi-channel signals and downmixing it into a 3.1-channel signal by using the principles of signal distribution and virtualization. Its hardware can be established by adding only one rear channel speaker on the basis of the 2.1 system. When comparing with the current multi-channel systems, the present invention simplifies the connections, cuts the cost, and provides ease of installation and use, and is especially suitable for achieving surround sound effect in family flat-panel TV, 3D TV or car surround speaker, and PC multimedia surround systems.

### CROSS-REFERENCE TO RELATED APPLICATIONS

This application claims priority under 35 U.S.C. §119(a) to Chinese Patent Application No. 2010-10568538.4, filed on Dec. 1, 2010, which is hereby incorporated by reference in its entirety.

### FIELD OF THE INVENTION

This invention is related to the audio technology field, especially to a method of downmixing multi-channel sounds into a 3-channel surround sound.

### BACKGROUND OF THE INVENTION

With the continuous improvement of living standards, the demands for audio system or flat-panel television system with audio function are increasing. The current mini-surround 2.1 system for flat-panel TV shown in FIG. 1 includes power amplifier, the left speaker, right speaker, and subwoofer, with the left speaker, and right speaker, and subwoofer being respectively connected with the power amplifier through wires. Although the 2.1 surround system to some extent can meet the consumers' needs, the sound effects of the 2-channel stereo or the virtual surround developed from 2-channel are far short from achieving a multi-channel surround, when compared with the multi-channel surrounds (such as 5.1, 6.1 or 7.1 multi-channel surround systems).

In the existing 5.1, or 6.1, and 7.1 multi-channel surround systems, shown in FIG. 2, the main amplifier in the 5.1 surround is generally placed in front of the whole system. In the meantime, due to the high fidelity requirements of the main speakers, the three groups of speakers in the front (left, middle, right) are connected with the main amplifier through wires, and the surround speakers are placed on the top backside of the main amplifier. For the subwoofer, it is difficult to place and route when connecting with wires because of its large size. It can be seen from FIG. 2 that although a multi-channel surround such as the 5.1 surround can be achieved, it has certain disadvantages, such as its high cost and cumbersome installation.

### SUMMARY OF THE INVENTION

This invention provides a method to downmix the multi-channel into 3-channel surround. This method can simplify the structure of multi-channel surround, achieving the sound effect of 5.1, 6.1 and 7.1 multi-channel surround via 3-channel. The method has the advantages of simplified connection and reduced cost, and provides ease of installation and usage, making it especially suitable for the uses in family flat-panel TV, 3D TV or car surround, and PC multimedia surround systems.

### BRIEF DESCRIPTION OF THE DRAWINGS

FIG. 1 illustrates a connection diagram for an existing 2.1 surround.

FIG. 2 illustrates a connection diagram for an existing 5.1 surround.

FIG. 3 illustrates a flow chart for how to mix the multi-channel into a 3-channel surround.

FIG. 4 illustrates a localization principle diagram for a 2-way stereo sound image.

FIG. 5 illustrates a diagram of the center channel virtualized from the left and right channels.

FIG. 6 illustrates a signal distribution map for the diagram of FIG. 5.

FIG. 7 illustrates a diagram of the left surround channel virtualized from the left channel and rear channel.

FIG. 8 illustrates a signal distribution map for the diagram of FIG. 7.

FIG. 9 illustrates a signal diagram for a multi-channel mixed into a 3-channel.

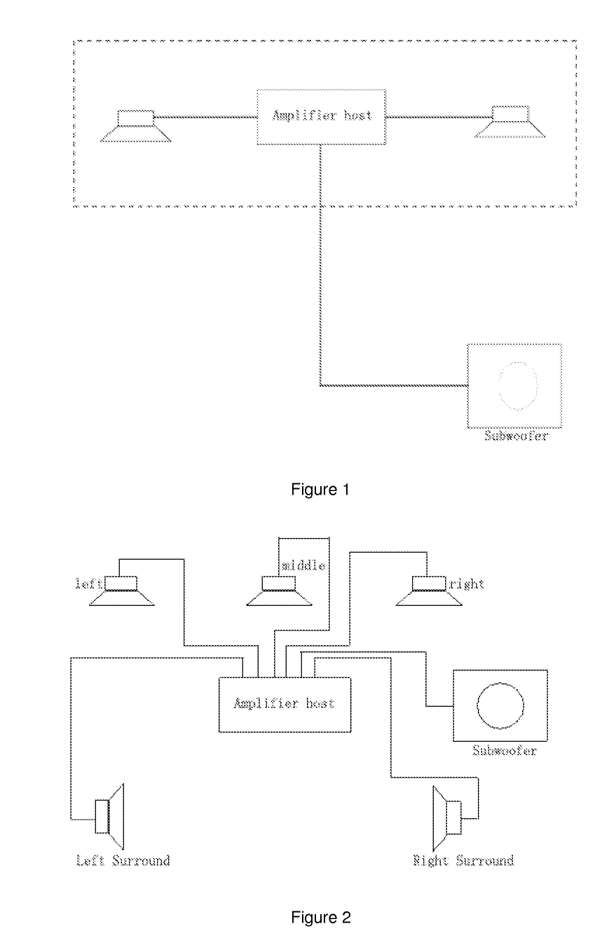

### DETAILED DESCRIPTION OF THE INVENTION

This invention provides a method to downmix the multi-channel into 3-channel surround. This method can simplify the structure of multi-channel surround, achieving the sound effect of 5.1, 6.1 and 7.1 multi-channel surround via 3-channel.

In one embodiment, the invention provides a method to downmix a multi-channel into a 3-channel surround, comprising the following steps:
a) decoding the data stream into a multi-channel signal; and
b) downmixing the decoded multi-channel signal into a 3.1-channel signal, which comprises a left channel signal, a right channel signal, a center signal, and a sub woofer signal; and
c) outputting the 3.1-channel signal via a 4-channel audio.

In another embodiment the present invention provides a method of downmixing multi-channel sounds into a 3-channel surround sound as described above, characterized in that step b) further comprises steps of:
b1) transmitting the decoded left channel and the right channel signal directly to the corresponding output;
b2) virtualizing the decoded center channel from the decoded center signal according to the localization principle of a 2-way stereo sound image;
b3) virtualizing left and right surround channels respectively from the decoded left and right surround signals according to the localization principle of 2-way stereo sound image and the principle of sound image extensions; and
b4) transmitting the decoded sub woofer signal directly to the corresponding output.

In another embodiment the present invention provides a method of downmixing multi-channel sounds into a 3-channel surround sound as described above, characterized in that between steps b3 and b4 the method further comprises a step of transmitting the decoded rear surround signal directly to the corresponding output via a rear channel.

In another embodiment the present invention provides a method of downmixing multi-channel sounds into a 3-channel surround sound as described above, characterized in that between step b3 and b4 the method further comprises a step of virtualizing rear left and rear right surround channels respectively from the decoded rear left and rear right surround channel signals according to the localization principle of 2-way stereo sound image and the principle of sound image extensions.

In another embodiment the present invention provides a method of downmixing multi-channel sounds into a 3-channel surround sound as described above, characterized in that step b2) further comprises the steps of: (i) processing signal correction on the decoded center channel signal, (ii) adding the corrected center channel signal with the left and right channels, and (iii) determining their additive ratio by a coefficient potentiometer.

In a preferred embodiment the present invention provides a method of downmixing multi-channel sounds into a 3-channel surround sound as described above, wherein the additive ratio is 0.707.

In another embodiment the present invention provides a method of downmixing multi-channel sounds into a 3-channel surround sound as described above, characterized in that step b3 further comprises signal correction processing of the decoded left surround and right surround signals firstly.

In a preferred embodiment the present invention provides a method of downmixing multi-channel sounds into a 3-channel surround sound as described above, wherein said multi-channel signal comprise 5.1, 6.1 and 7.1 channel signals.

In another embodiment the present invention provides a method of downmixing multi-channel sounds into a 3-channel surround sound as described above, characterized in that the data stream is supplied by a sound source encoded with Dolby surround or DTS surround.

Compared with existing technologies, the present invention has the following beneficial effects: the invention reprocesses the traditional multi-channel (after decoding) signals and downmix the multi-channel into a 3.1 channel by using the signal distribution principle and the virtual principle; the hardware is achieved by adding only one way rear channel speaker on the basis of the 2.1 system, which can achieve the playback effect of the existing multi-channel speakers such as 5.1 or 6.1 and 7.1 multi-channel surround systems.

In addition, the method of the present invention has advantages of the simplified connection, greatly reduced cost, and convenience of installation and usage; which make it more suitable for achieving the sound effects of the family flat panel TV, 3D TV or car surround, and PC multimedia surround systems.

### EXAMPLES

The present invention is described more fully by way of the following non-limiting examples. To make the objective, technical solution and merits of this invention more clear, further details are provided by the combination of drawings and embodiments below. It should be understood that the specific examples described here are only used for explaining this invention, not to be used to limit this invention.

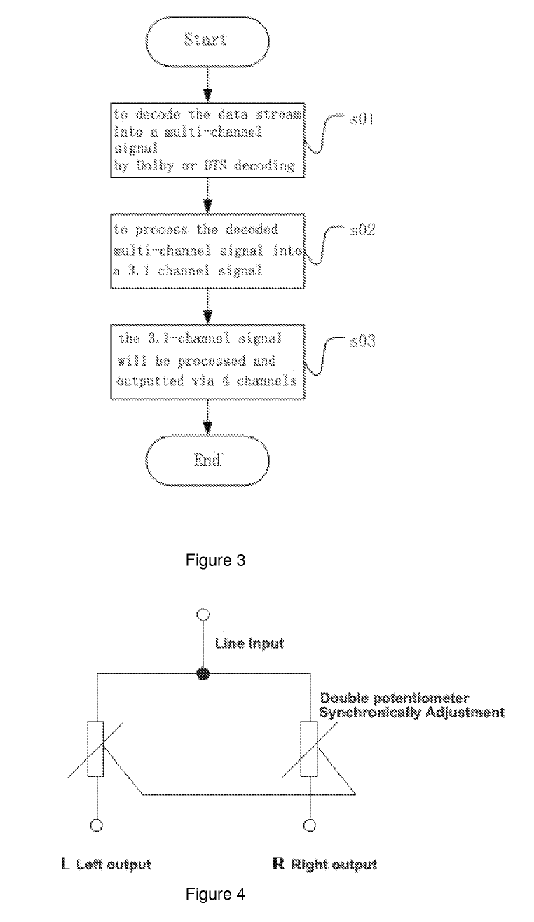

### FIG. 3 Includes Steps As Illustrated Below

Step s01: to decode the data stream into multi-channel signal by Dolby or DTS; in which the multi-channel signal can be 5.1, 6.1 or 7.1 channel signal, and meanwhile a 5.1 channel includes the front “left channel L”, “the center channel C”, “right channel R”, the rear “left surround channel SL,” and “right surround channel SR”. The frequencies of these channels are all in the full-frequency range of 3-20000 Hz, including a subwoofer SW, which is called “0.1” channel because the channel's frequency response is 3-120 Hz and not complete.

Similarly, the 6.1 channel consists of 5.1 and a “rear surround channel SB”, while the 7.1 channel is to separate the “rear surround channel SBL” in the 6.1 channel into “left rear surround channel SBR” and “right rear surround channel”.

The above mentioned data stream is supplied by the sound source encoded with Dolby surround or DTS surround, which inputs the data stream into the special decoding chip, which isolates the 5.1 signal (or 6.1, 7.1 signal).

Step s02: to remix the decoded multi-channel signal into 3.1 channel signal;

### The 5.1 Channels Include the Steps As Illustrated Below

Step s021: no processing for decoded left channel L signal and right channel R signal, but directly transmitted to the corresponding output.

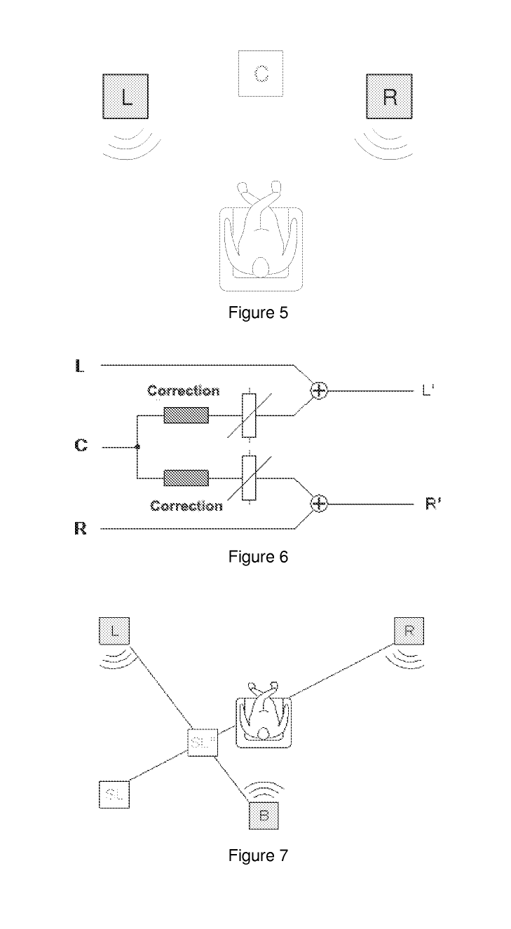

Step s022: C signals in the decoded center channel signals are respectively assigned to the left channel and right channel of the 3.1 channel according to FIG. 4 and the localization principle of 2-way stereo sound image, and the central channel C channel is finally virtualized from the left channel L and right R, as shown in FIG. 5. FIG. 6 is the signal distribution graph; the decoded C channel will be correctively processed and then put with L and R channels; the additive ratio will be 0.707, and their additive factor is determined by the potentiometer shown in FIG. 6.

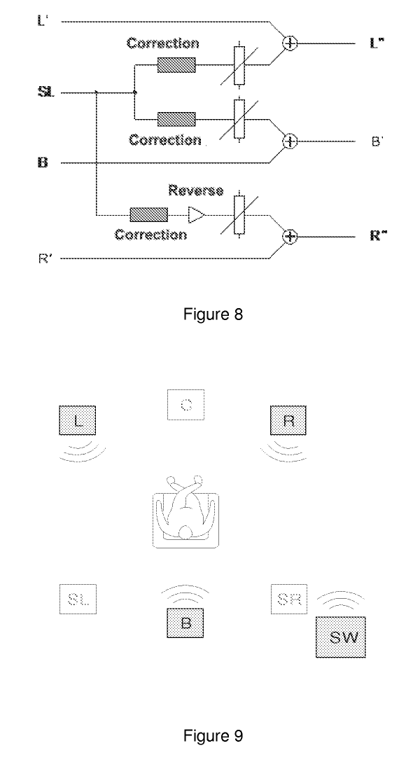

Step s023: based on FIG. 4, to assign the left channel L and rear channel B of 3.1 channel firstly according to the localization principles of 2-way stereo sound image and the extension principle; SL is virtualized by L and B channels, and then to take the SL″ and R channels as a pair of bi-channel; to process the SL″ signal as the localization principle of outside 2 channel systems and then broaden the sound image, that is, to get a virtual SL channel by reversely mixing the SL″ signal into R channel. FIG. 7 is diagram; FIG. 8 is the signal distribution graph; and the distribution factor and the correction processing parameter will be adjusted accordingly based on different location of the sound image of the virtual SL.

Step s024: Based on Step s023, a virtual SR channel can be obtained from a decoded right surround SR signal according to the localization principle of 2-way stereo sound image and the extension principle.

### The 6.1 Channels Include the Steps As Illustrated Below

Step s02a: to transmit the decoded left channel L signal and R signal directly to the corresponding output without processing.

Step s02b: Based on FIG. 4, C signals in the decoded center channel signals are assigned to the left channel L and right channel R, respectively, of the 3.1 channel according to the localization principle of 2-way stereo audio, and the central channel C channel is finally virtualized from the left channel L and right R as shown in FIG. 5. FIG. 6 is the signal distribution graph, and the decoded C channel will be correctively processed, and then put with L and R channels, with an additive ratio of 0.707, and the additive factor determined by a potentiometer shown in FIG. 6.

Step s02c: Based on FIG. 4, to assign the decoded left surround SL signal to the left channel and the rear channel B of 3.1 channel according to the localization principles of 2-way stereo sound image and the extension principle; the SL″ is virtualized by L and B channels, and then to take the SL″ and R channels as a pair of bi-channel; to process the SL″ signal as the localization principle of outside 2-channel systems and then broaden the sound image, that is, to get a virtual SL channel by reverse-mixing the SL″ signal into R channel as shown in FIG. 7; FIG. 8 is the signal distribution graph, and the distribution factor and the correction processing parameter in FIG. 8 can be adjusted accordingly based on different locations of sound image of the virtual SL.

Step s02d: Based on Step s023, a virtual SR channel can be obtained from a decoded right surround SR signal according to the localization principle of 2-way stereo sound image and the extension principle.

Step s02e: to transmit the decoded rear surround SB signal directly to the rear channel B without processing.

### The 7.1 Channels Include the Steps As Illustrated Below

Step s02A: transmit the decoded left channel L signal and R signal directly to the corresponding output without processing.

Step s02B: Based on FIG. 4, C signals in the decoded center channel signals are assigned to the left channel and right channel, respectively, of the 3.1 channel according to the localization principle of 2-way stereo sound image, and the C channel is finally virtualized from the left channel L and right R as shown in FIG. 5. FIG. 6 is the signal distribution graph, and the C channel after decoding will be correctively processed, and then put with L and R channels, as a result the additive ratio will be 0.707, with the additive factor determined by the potentiometer shown in FIG. 6.

Step s02C: Based on FIG. 4, to assign the decoded left surround SL signal to the left channel L and the rear channel B of 3.1 channel according to the localization principles of 2-way stereo sound image and the extension principle; the SL″ is virtualized by L and B channels, and then to take the SL″ and R channels as a pair of bi-channel; to process the SL″ signal as sound image localization principle outside 2-channel systems and then broaden the sound image, that is, to get a virtual SL channel by reverse-mixing the SL″ signal into R channel as shown in FIG. 7; FIG. 8 is the signal distribution graph, and the distribution factor and the correction processing parameter in FIG. 8 can be adjusted accordingly based on different locations of sound image of the virtual SL.

Step s02D: Based on Step s023, a virtual SR channel can be obtained from a decoded right surround SR signal according to the localization principle of 2-way stereo sound image and the extension principle.

Step s02E: a virtual surround back left channel SBL and a virtual surround back right channel SBR are obtained from the decoded surround back left channel SBL signal and surround back right SBL in the corresponding processing procedures of steps s02C and s02D.

In FIG. 6 and FIG. 8, the amendments in the small black box refer to the amendments of relevant factors in accordance with relevant factors of sound source localization algorithm and orientation principle of sound source distance. There is no treatment on the decoded subwoofer SW signal; it will directly correspond to the transmission output.

Step s03: the 3.1 channels after downmixing consist of a new left channel L, a new right channel R, a new back channel B and a subwoofer SW, which constitutes a playback form with 4 channel amplifier and speakers as shown in FIG. 9.

The foregoing examples and description of the preferred embodiments should be taken as illustrating, rather than as limiting the present invention as defined by the claims. As will be readily appreciated, numerous variations and combinations of the features set forth above can be utilized without departing from the present invention as set forth in the claims. Such variations are not regarded as a departure from the spirit and principle of the invention, and all such variations are intended to be included within the scope of the following claims.

What is claimed is:

1. A method of downmixing multi-channel sounds into a 3-channel surround sound, comprising the steps of:
a) decoding the data stream into a multi-channel signal;
b) down-mixing the decoded multi-channel signal into a 3.1-channel signal, which comprises a left channel signal, a right channel signal, a center signal, and a sub woofer signal; and
c) outputting the 3.1-channel signal via a 4-channel audio.

2. The method of claim 1, characterized in that the step b) further comprises steps of:
b1) transmitting the decoded left channel and the right channel signal directly to the corresponding output;
b2) virtualizing the decoded center channel from the decoded center signal according to the sound image localization principle of a 2-way stereo audio;
b3) virtualizing left and right surround channels respectively from the decoded left and right surround signals according to the sound image localization principle of 2-way stereo audio and the principle of sound image extensions; and
b4) transmitting the decoded sub woofer signal directly to the corresponding output.

3. The method of claim 2, characterized in that between the steps b3) and b4) the method further comprises a step of transmitting the decoded rear surround signal directly to the corresponding output via a rear channel.

4. The method of claim 2, characterized in that between the steps b3) and b4) the method further comprises a step of virtualizing rear left and rear right surround channels from the decoded rear left and rear right surround channel signals, respectively, according to the sound image localization principle of 2-way stereo audio and the principle of sound image extensions.

5. The method of claim 2, characterized in that the step b2) further comprises steps of: (i) processing signal correction on the decoded center channel signal, (ii) adding the corrected center channel signal with the left and right channels, and (iii) determining their additive ratio by a coefficient potentiometer.

6. The method of claim 5, characterized in that the additive ratio is 0.707.

7. The method of claim 4, characterized in that step b2 further comprises steps of: (i) processing signal correction on the decoded center channel signal, (ii) adding the corrected center channel signal with the left and right channels, and (iii) determining their additive ratio by a coefficient potentiometer.

8. The method of claim 7, characterized in that the additive ratio is 0.707.

9. The method of claim 2, characterized in that step b3 comprises signal correction processing of the decoded left surround and right surround signals.

10. The method of claim 4, characterized in that step b3 comprises signal correction processing of the decoded left surround and right surround signals.

11. The method of claim 1, characterized in that the multi-channel signals comprise a signal selected from 5.1, 6.1 and 7.1 channel signals.

12. The method of claim 1, characterized in that the data stream is supplied by a sound source encoded with Dolby surround or DTS surround.
